(19) United States
(12) Patent Application Publication
(10) Pub. No.: US 2023/0367998 A1
(43) Pub. Date: Nov. 16, 2023

(54) Hybrid Fixed/Flexible Neural Network Architecture

(71) Applicant: PolyN Technology Limited, Bristol (GB)

(72) Inventors: DMITRI GODOVSKIY, Bucharest (RO); Boris Maslov, Palmetto, FL (US); Aleksandrs Timofejevs, Riga (LV); Nikolai Kovshov, Tbilisi (GE)

(21) Appl. No.: 18/196,412

(22) Filed: May 11, 2023

Related U.S. Application Data
(63) Continuation-in-part of application No. 17/189,109, filed on Mar. 1, 2021.
Application No. 17/189,109 is a continuation of application No. PCT/RU2020/000306, filed on Jun. 25, 2020.
Application No. PCT/RU2020/000306 is a continuation-in-part of application No. PCT/EP2020/067800, filed on Jun. 25, 2020.

(51) Int. Cl. G06N 3/0455; G06N 3/0895

(52) U.S. Cl. CPC G06N 3/0455; G06N 3/0895

(57) ABSTRACT

A hybrid analog-digital hardware apparatus and a method for realizing the hardware apparatus are provided. The hardware apparatus includes an analog circuit that includes a plurality of operational amplifiers and a plurality of resistors. The analog circuit is configured to receive an analog signal from one or more sensors, and compute an analog output based on the analog signal, by performing a portion of a trained neural network. In some implementations, the hardware apparatus includes an analog-to-digital converter coupled to the analog circuit and configured to receive and convert the analog output to a digital input. The hardware apparatus also includes a classifier or regression circuit coupled to the analog circuit. The classifier or regression circuit is configured to receive output (e.g., a set of embeddings) from the analog circuit, and classify the output to obtain a result according to a machine learning model.

### CROSS-REFERENCE TO RELATED APPLICATIONS

This application is a continuation-in-part of U.S. application Ser. No. 17/189,109, filed Mar. 1, 2021, entitled “Analog Hardware Realization of Neural Networks,” which is a continuation of PCT Application No. PCT/RU2020/000306, filed Jun. 25, 2020, entitled “Analog Hardware Realization of Neural Networks,” each of which is incorporated by reference herein in its entirety. U.S. application Ser. No. 17/189,109 is also a continuation-in-part of PCT Application PCT/EP2020/067800, filed Jun. 25, 2020, entitled “Analog Hardware Realization of Neural Networks,” which is incorporated by reference herein in its entirety.

### TECHNICAL FIELD

The disclosed implementations relate generally to neural networks, and more specifically to hybrid neural network hardware containing an initial fixed portion (e.g., analog) and a second flexible portion (e.g., digital).

### BACKGROUND

Conventional hardware has failed to keep pace with innovation in neural networks and the growing popularity of machine learning based applications. The complexity of neural networks continues to outpace CPU and GPU computational power as digital microprocessor advances are plateauing. Neuromorphic processors based on spike neural networks, such as Loihi and True North, are limited in their applications. For GPU-like architectures, power and speed are limited by data transmission speed. Data transmission can consume up to 80% of chip power and can significantly impact the speed of calculations. Edge applications demand low power consumption, but there are currently no known performant hardware implementations that have the needed low power consumption (e.g., consume less than 50 milliwatts of power).

The neural network training process presents unique challenges for hardware realization of neural networks. A trained neural network is used for specific inferencing tasks, such as classification or regression. Once a neural network is trained, a hardware equivalent is manufactured. When the neural network is retrained, the hardware manufacturing process is repeated, driving up costs. Although some reconfigurable hardware solutions exist, such hardware cannot be easily mass produced, and costs a lot more (e.g., five times more) than hardware that is not reconfigurable. Conventional neuromorphic analog signal processors have fixed weights, which cannot be adjusted after a chip is manufactured.

### SUMMARY

Accordingly, there is a need for methods, circuits and/or interfaces that address at least some of the deficiencies identified above. Analog circuits that model trained neural networks and are manufactured according to the techniques described herein, can provide improved performance per watt, can be useful in implementing hardware solutions in edge environments, and can tackle a variety of applications, such as drone navigation and autonomous cars. The cost advantage provided by these manufacturing methods and/or analog network architectures are even more pronounced with larger neural networks. Also, analog hardware implementations of neural networks provide improved parallelism and neuromorphism. Moreover, neuromorphic analog components are not sensitive to noise and temperature changes, when compared to digital counterparts.

Chips manufactured according to the techniques described herein provide an order of magnitude improvement over conventional systems in size, power, and performance, and are ideal for edge environments, including for retraining purposes. Such analog neuromorphic chips can be used to implement edge computing applications or in Internet-of-Things (IoT) environments. Due to the analog hardware, initial processing (e.g., formation of descriptors for image recognition), which can consume over 80-90% of power, can be moved onto a chip, thereby decreasing energy consumption and network load for new applications.

A hybrid approach to neuromorphic computing is described herein, according to some implementations. Similar to a human brain, an artificial neural network can include a fixed part and a flexible part. The flexible part can be changed for a new classification or regression task. According to some implementations, a hybrid neuromorphic analog signal processor combines (i) a fixed part to support fixed weights and (ii) a flexible part responsible for classification or regression. The flexible part may operate on output produced by the fixed part. The flexible part can change based on updated needs after manufacturing. The flexible part may be implemented as arrays of memristors and/or arrays of SuperFlash memory with some determined architecture.

In machine learning, after several hundred training cycles (sometimes referred to as epochs), a deep convolutional neural network typically maintains fixed weights and structure for the first 80-90% of the layers. In the following cycles, only a few last layers that are responsible for classification or regression continue to change weights. This property is also used in transfer learning. This property may be used for implementing the hybrid architecture described herein. A fixed neural network that is responsible for pattern detection (embeddings) is combined with a following flexible algorithm (e.g., a flexible neural network) that is responsible for pattern interpretation. According to some implementations, a hybrid core includes a fixed neuromorphic analog core that is configured to generate embeddings. This part consumes ultra-low power and provides low latency. The hybrid core also includes a flexible part that can be used for final classification or regression.

In some implementations, a hardware device includes an analog circuit and a classifier or regression circuit. The analog circuit corresponds to a portion of a trained neural network. The analog circuit is configured to obtain one or more analog signals from one or more sensors and compute an analog output based on the one or more analog signals. The classifier or regression circuit is coupled to the analog circuit. The classifier or regression circuit is configured to (1) obtain an input signal based on the analog output and (2) apply a machine learning model to the input signal to either (i) classify the input signal according to a plurality of discrete categories or (ii) assign an output on a predefined continuous scale.

In some implementations, the classifier or regression circuit comprises a digital circuit and the hardware apparatus further includes an analog-to-digital converter (ADC) coupled to the analog circuit. The ADC is configured to receive and convert the analog output to a digital input.

In some implementations, the analog output comprises a set of latent embeddings and the classifier or regression circuit applies the machine learning model to the latent embeddings.

In some implementations, the analog circuit comprises a plurality of operational amplifiers and a plurality of resistors. Resistance values of the plurality of resistors are based on weights of neurons in the portion of the trained neural network. The resistors are configured to connect the plurality of operational amplifiers. In some implementations, the analog circuit comprises sputtered resistors in a backend-of-the-line (BEOL).

In some implementations, the classifier or regression circuit comprises one or more digital computing units selected from the group consisting of: CPUs, GPUs, RISCs, FPGAs, and ASICs.

In some implementations, the classifier or regression circuit comprises a processor that is further configured to perform as a digital controller, providing signals to one or more interfaces and multiplexing power within the hardware apparatus.

In some implementations, the classifier or regression circuit comprises a compute-in-memory component and one or more programmable memory tiles.

In some implementations, the classifier or regression circuit comprises a network of memristors.

In some implementations, the trained neural network is an autoencoder comprising an encoder portion, having a plurality of hidden layers that compute a respective representation of each input vector in a lower dimensional space than an input space of the respective input vector, and a decoder portion that reconstructs the respective input vector. The analog circuit corresponds to the encoder portion and the classifier or regression circuit corresponds to the decoder portion.

In some implementations, the classifier or regression circuit is reconfigurable to train the machine learning model for a new set of inputs that is different from a set of inputs used to train the trained neural network.

In some implementations, the one or more sensors include at least one analog sensor. The analog sensor is a microphone, a piezoelectric sensor, a PPG sensor, an IMU sensor, a chemical sensor, a Lidar sensor, a Radar sensor, or a CMOS matrix sensor.

In some implementations, the analog circuit is configured to generate embeddings that encode types of human activity, and the analog signal comprises three-axis accelerometer signals.

In some implementations, the analog circuit is configured to generate compressed data that encodes vibration sensor data based on vibration features from vibration sensors, and the analog signal comprises three-axis accelerometer signals. In some implementations, the vibration sensors are configured to be placed in machinery, cars, tracks, railway cars, wind turbines, or oil and gas pumps, and the analog signal is obtained wirelessly from the vibration sensors.

In some implementations, the analog circuit is configured to generate embeddings that encode a first set of keywords, and the classifier or regression circuit is configured to be retrained for a second set of keywords that is distinct from the first set of keywords.

In some implementations, the analog circuit is configured to generate pseudo-labels for unlabeled data for self-supervised representation learning.

In another aspect, a method is provided for splitting neural networks. The method includes obtaining a multi-layered neural network that includes a plurality of layers of neurons. The method also includes selecting a set of layers of the multi-layered neural network. The set of layers includes a first layer of neurons and ends with a candidate layer of neurons. The method also includes generating embeddings output by the candidate layer of neurons by inputting a set of input vectors to the multi-layered neural network. The method also includes training a classifier or regressor to classify or regress the embeddings. The method also includes evaluating the classifier or regressor using a test set to determine a performance metric for the classification or regression. The method also includes, in accordance with a determination that the performance metric for the classification is above a predetermined threshold, repeating selecting a new set of layers based on the set of layers, generating new embeddings using the new set of layers, training the classifier or regressor to classify or regress the new embeddings, and evaluating the classifier using the test set, until the performance metric is below the predetermined threshold.

In some implementations, selecting the set of layers and selecting the new set of layers are based on determining if (i) number of operations, (ii) number of neurons, and (iii) dimension of resulting embeddings, are below respective predetermined threshold values.

In some implementations, selecting the set of layers and selecting the new set of layers are based on calculating energy per operation by simulating the multi-layered neural network.

In some implementations, selecting the set of layers and selecting the new set of layers are based on estimating energy per operation based on supply voltage, propagation time and average working current per neuron, for the multi-layered neural network.

In some implementations, the method further includes repeating the steps for a predetermined number of iterations.

In some implementations, the method further includes using a new classifier for classifying the new embeddings after repeating the steps a predetermined number of iterations.

In some implementations, the plurality of layers of neurons includes the first layer of neurons for receiving inputs, and wherein each layer of neurons of the plurality of layers of neurons is connected to a subsequent layer of neurons of the plurality of layers of neurons.

In some implementations, a computer system has one or more processors and memory. The one or more programs include instructions for performing any of the methods described herein.

In some implementations, a non-transitory computer readable storage medium stores one or more programs configured for execution by a computer system having one or more processors and memory. The one or more programs include instructions for performing any of the methods described herein.

Thus, methods, systems, and devices are disclosed that are used for hardware realization of neural networks.

### BRIEF DESCRIPTION OF THE DRAWINGS

For a better understanding of the aforementioned systems and methods, as well as additional systems and methods for hybrid fixed/flexible implementations of neural networks, reference should be made to the Description of Implementations below, in conjunction with the following drawings in which like reference numerals refer to corresponding parts throughout the figures.

FIG. 1A is a schematic diagram of a system for hardware realization of neural networks using hybrid hardware components, according to some implementations.

FIG. 1B is a conceptual block diagram of hybrid hardware for realizing neural networks, according to some implementations.

FIG. 1C is a schematic diagram of an example method for realizing a classifier based on autoencoders, according to some implementations.

FIG. 1D provides a schematic diagram comparing (i) a process flow for classification using conventional digital neural network models and (ii) a process flow for classification using hybrid hardware based on techniques described herein, according to some implementations.

FIG. 2 is a block diagram of a computing device for splitting neural networks for hybrid hardware realization of neural networks in accordance with some implementations.

FIGS. 3A-3C provide a schematic diagram of a process for splitting an example keyword spotting neural network, according to some implementations.

FIG. 4 has a flowchart of a method for splitting neural networks for hybrid hardware realization of neural networks in accordance with some implementations.

Reference will now be made to implementations, examples of which are illustrated in the accompanying drawings. In the following description, numerous specific details are set forth in order to provide a thorough understanding of the present invention. However, it will be apparent to one of ordinary skill in the art that the present invention may be practiced without requiring these specific details.

### DESCRIPTION OF IMPLEMENTATIONS

Some implementations realize neural networks in hardware by splitting the neural network into two parts. A first fixed part includes fixed weights and is realized using an analog circuit. In some implementations, the fixed circuit is implemented using a neuromorphic analog signal processor. A second flexible part includes programmable weights. In some implementations, the second flexible part is realized using a digital processor, which may be included as part of the neuromorphic analog signal processor chip or may be an external processor or device. In some implementations, the second flexible part uses arrays of memristors and/or arrays of SuperFlash memory with some determined architecture.

In this way, the advantages of a neuromorphic analog signal processor, such as low latency and high power efficiency, may be combined with the flexibility of the second flexible part.

Described herein are example hardware and techniques for splitting neural networks into the two parts, according to some implementations.

In machine learning, after many training cycles (sometimes referred to as epochs), a deep convolutional neural network model maintains fixed weights and structure for the first 80-90% of the layers. In the following training cycles, weights change only in the last few of the neural network layers (e.g., layers responsible for classification). This property is also used in transfer learning techniques. This property or characteristic of neural networks is a basis for the hybrid hardware described herein. In some implementations, a fixed neural network is responsible for pattern detection (creating a dense set of latent embeddings or descriptors). This is combined with a following flexible algorithm. In some implementations, this algorithm includes an additional flexible neural network responsible for pattern interpretation, according to the nature of the application.

Embeddings (also referred to as latent embeddings or descriptors) are a representation containing densely packed information about sensory input. Embeddings are formed by a neural network similar to a biological nervous system. Embeddings can be found in visual neurobiology. For example, the retina in the eye compresses and encodes visual sensory signals for the visual cortex. The visual cortex is then able to classify and extract meaning for further decision making. Embeddings are formed in hidden layers of a neural network. Embeddings contain significant information about input data. Embeddings are used as input data for further efficient processing, such as data classification and interpretation.

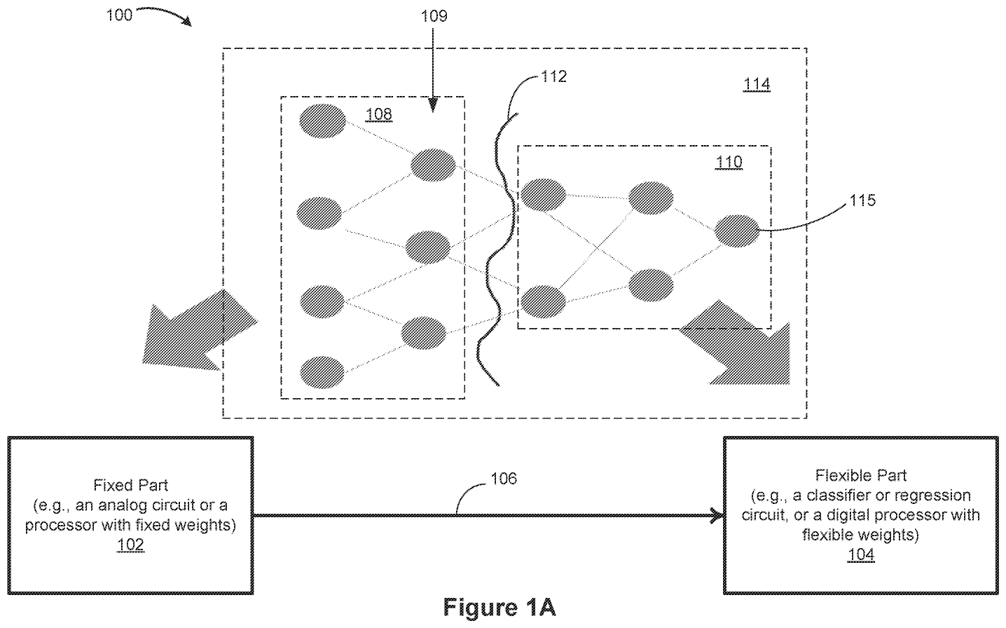

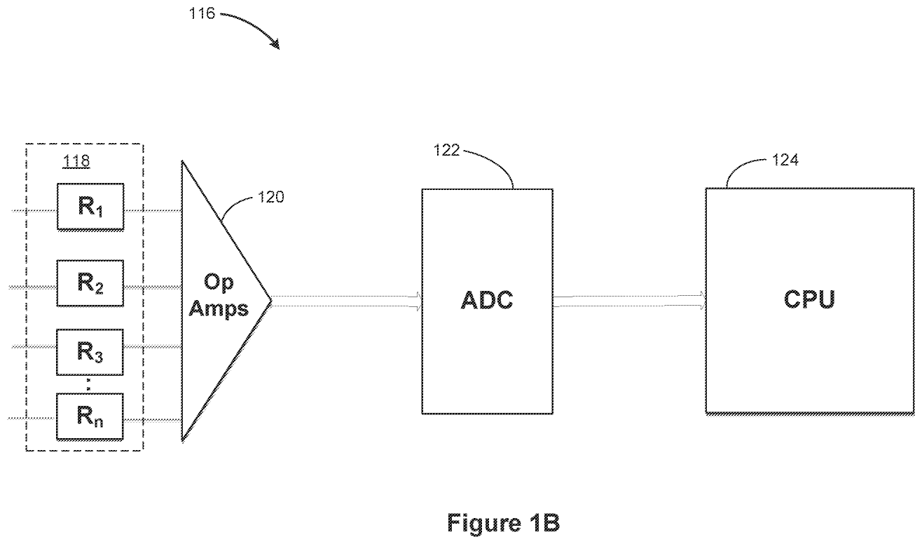

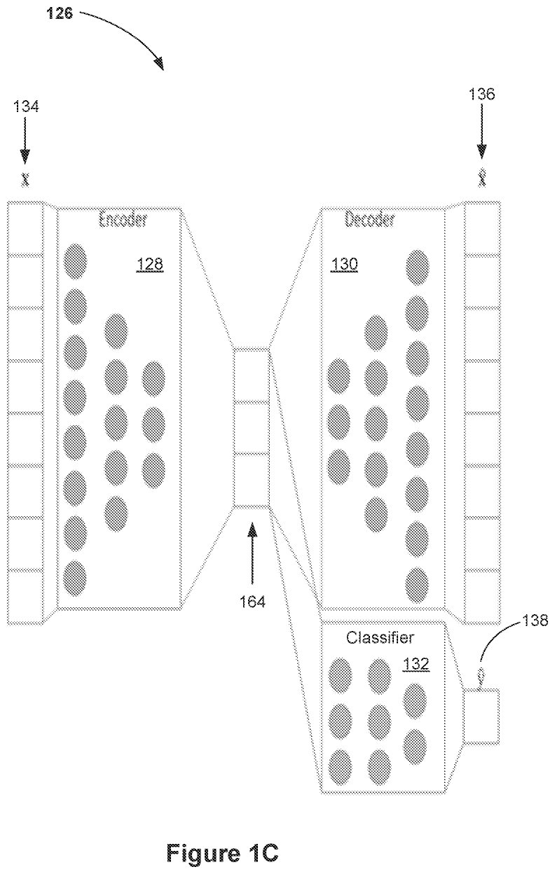

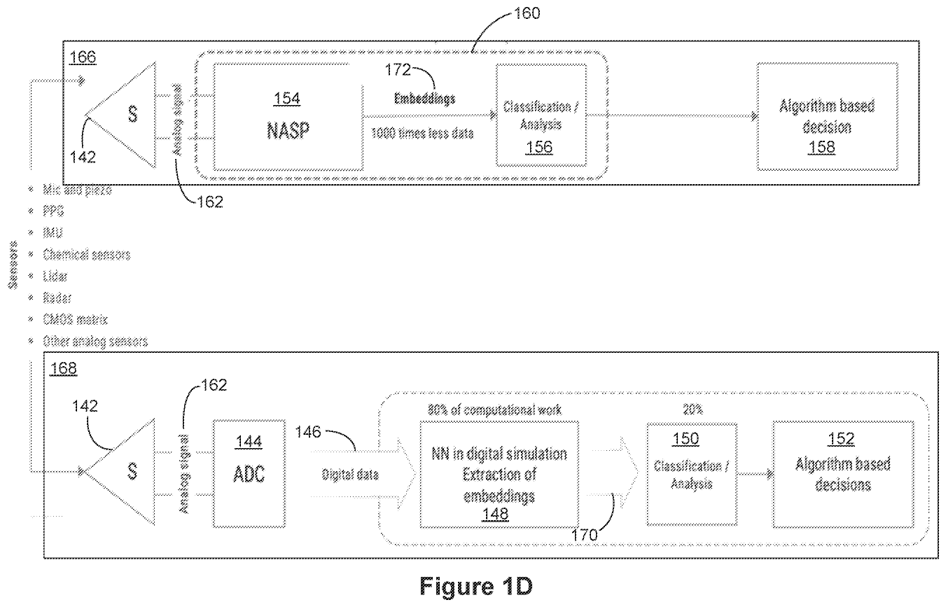

FIG. 1A is a schematic diagram of a system 100 for hardware realization of neural networks 114 using hybrid hardware components, according to some implementations. In this example, a neural network 114 (sometimes referred to as a multi-layered neural network) includes two portions or sets of layers 108 and 110. The first set of layers 108 includes layers of neurons (circles in FIG. 1A) that take an input vector and produce an intermediate output. The very first layer is sometimes referred to as the input layer and other layers (except for an output layer) are referred to as hidden layers of the neural network. The second set of layers 110 takes the output (sometimes referred to as embeddings) of the last layer 109 (the last layer 109 is sometimes referred to as a candidate layer) as input and produces an output at the output layer. In this example, the output layer includes a single neuron 115, but this need not be true. The layers may have any number of neurons. The neural network is trained and includes weights associated with edges that connect the neurons. The techniques described herein can be used to realize the neural network using a hybrid hardware that includes a fixed part 102 (e.g., an analog circuit or a processor with fixed weights, or weights that are hardwired or cannot be changed after a chip is fabricated) coupled to (via an interface 106, such as an analog-to-digital converter) a flexible part 104 (e.g., a classifier or regression circuit or a digital processor with flexible weights). A method for splitting (112) the neural network is also described herein, according to some implementations. The splitting includes identifying a candidate layer 109 for the neural network 114, according to some implementations.

Some implementations include (i) a fixed neuromorphic analog core configured to generate embeddings with ultra-low power and low latency, and (ii) a flexible digital core for final classification or regression. FIG. 1B is a block diagram of hybrid hardware 116 for realizing neural networks, according to some implementations. In some implementations, the fixed neuromorphic analog core includes operational amplifiers 120, which represent nodes of the neural network and resistors 118 that represent connections of the neural network. Values of these analog components can be fixed during manufacturing. For example, the values of resistances are calculated using a compiler and may not be changed after the chip is manufactured. In some implementations, the connections are represented by sputtered resistors in BEOL of the chip. Example methods for realizing neural networks and/or manufacturing or fabricating such chips using analog hardware (e.g., using operational amplifiers, using resistors, and estimating resistance values) are described in detail in U.S. application Ser. No. 17/189,109, filed Mar. 1, 2021, entitled “Analog Hardware Realization of Neural Networks,” which is incorporated by reference herein in its entirety. Hybrid hardware described herein includes one or more interfaces (e.g., an analog-to-digital converter 122) configured to couple the analog hardware (e.g., the analog circuit comprising the operational amplifiers 120 and the resistors 118 interconnecting the operational amplifiers) with classifier or regression hardware 124 (e.g., a digital processor, including a CPU). The analog circuit is configured to implement a first set of layers 108 using analog components. For example, values for the operational amplifiers and/or resistance values may be determined based on weight values of an input neural network and its topology. The classifier or regression hardware 124 (sometimes referred to as a classifier or regression circuit) is configured to implement the second set of layers 110 following the candidate layer 109. A regression circuit maps an input signal to a continuous digital output according to a machine learning model. A regression circuit typically implements a regression algorithm that uses the embeddings to map an analog output to continuous digital values. The classifier or regression circuit performs classification or regression functions, may be reconfigured to have different weights for different applications, different instances of an application, different users, and/or use cases.

A large number of machine learning tasks require flexible weights. The fixed part 102 may be implemented using sputtered resistors on the BEOL of the chip. In some implementations, the flexible part 104 is realized using a digital micro-controller unit (MCU) coupled to a neuromorphic analog signal processor (the fixed part). In some implementations, the flexible part is realized using a RISC V processor, which may be an integral part of the neural analog signal processor. The flexible part can be a neural network or an algorithm, such as k-nearest neighbors (KNN).

A classification or regression task may be viewed as having two stages. In the first stage, v=G(x, WG), where x is the input data, xϵR^{N} (R is the set of real numbers and N is the number of dimensions of the input data), G is a neural network for building embeddings, WG is a set of trainable parameters of G, and v is an embedding with vϵR^{M} (M is the number of dimensions of the output data). Typically, M is much smaller than N. In the second stage, y=C(v, WC), where C is a classifier, WC is a set of trainable parameters of C, and y is a classification result corresponding to the input vector x. In some cases, C is a discrete classifier, assigning one of a set of categorical values to each input vector x. In some cases, C computes a regression value based on the set of embeddings v, assigning a classification result on a continuous scale. A regression calculator can be considered as a continuous classifier.

In machine learning, a large portion (e.g., 80-90%) of the neural network weights are typically unchanged after several epochs of training. Transfer learning can be used to realize such neural networks. For example, a new neural network may be implemented with a fixed part for the large portion of the network and a flexible part (e.g., the remaining 10-20%), which can be trained separately. Some implementations combine fixed parts of neural networks (e.g., using resistors) and flexible parts of network (e.g., realized using a digital processor, either in an MCU of the device, at a RISC-V processor, an FPGA, or a CPU), as part of a neuromorphic analog signal processor chip. In some implementations, the flexible part of a network is implemented using conventional technologies and programming languages used in software development, such as Python, C/C++, assembly code, and specialized frameworks, such as TensorFlow or Torch. The implementation is then run on conventional digital computing units, such as a CPU, a GPU, a RISC processor, or an FPGA, depending on the target device and/or application.

Example Methods for Splitting a Neural Network into Fixed and Flexible Parts

FIG. 1C is a schematic diagram of an example method 126 for realizing a classifier based on autoencoders using the techniques described herein, according to some implementations. An autoencoder constructs an output vector \hat{x} 136 that closely matches the input vector x 134 after nonlinear transformations are performed by hidden layers. The autoencoder consists of an encoder 128 and a decoder 130. The encoder contains one or more hidden layers. The encoder computes a representation 164 of the input vector 134 in a space with fewer dimensions than the input space. The decoder 130 processes the representation 164 and reconstructs the input. The representation 164 is an embedding obtained by projecting the input vector 134 onto a representation space. The embedding 164 may also be further processed by a classifier 132 to obtain a result vector 138 (e.g., using discrete or continuous classification or regression).

According to some implementations, in the first stage, the autoencoder is trained. The number of training epochs is determined by reconstruction error calculated between output and input vectors. After training the autoencoder, its encoder is used to transform an input vector onto the representation space. In the second stage, a classifier for a particular task is trained. The space for this task is the same as the space in which the autoencoder was trained. All of the vectors from this task space are transformed onto the representation space by means of the encoder. The classifier is built in this representation space. The classifier processes vectors after transformation by the encoder. The number of training epochs for the classifier is determined by the resulting accuracy. In this way, an encoder is trained once and implemented in a fixed part of the system. A classifier is trained for a particular task and implemented in a flexible part of the system.

In some implementations, self-supervised representation learning (SSRL) provides deep feature learning without the requirement of large, annotated data sets. In some implementations, a binary classification neural network is trained to compare pairs of input vectors. When both inputs are the same or transformations of the same base vector, the classifier outputs a first class (e.g., “1”). For two fully different input vectors, the classifier outputs a second class (e.g., “0”).

Typically, this type of neural network contains two branches (one for each of two inputs) with shared weights for processing two input vectors. The embeddings obtained at the output layer of these branches are then fed to a classifier for comparing them. These parts are trained in an end-to-end manner. The number of training epochs is determined by a target binary classification error. The branches generating the embeddings play the same role as encoders in the autoencoder described above. Similar to the example method described above for autoencoders, a classifier is separately trained for a particular downstream classification task. The number of training epochs for the classifier is determined by the classification or regression accuracy. A branch generating an embedding is trained once and implemented in a fixed part of the system. A classifier is trained for a particular task and implemented in a flexible part of the system.

FIG. 1D provides a schematic diagram comparing a conventional process flow 168 for classification using conventional digital neural network models and a hybrid process flow 166 for classification using hybrid hardware based on techniques described herein, according to some implementations. In the standard flow 168, the analog signal 162 from one or more analog sensors 142 is input to an analog-to-digital converter (ADC) 144 which generates digital data 146. The digital data 146 is input into a neural network digital simulation 148, which extracts the embeddings 170. The embeddings are classified or analyzed (150), which is further processed for algorithm based decisions 152. About 80% of the computational work is performed in the digital simulation 148.

In the hybrid process flow 166, on the other hand, the analog signal 162 from the one or more sensors 142 is input into a neuromorphic analog signal processor 154, which may implement the analog circuit described above. The neuromorphic analog signal processor 154 generates embeddings 172 (which may be similar to the embeddings 170). The embeddings are input into a classification or analysis circuit 156 (sometimes referred to as the classifier), which may be similar in functionality to the digital classification module 150. Unlike the standard flow 168, a majority of the computations use the hybrid hardware 160, including the neuromorphic analog signal processor 154 and the classification and analysis circuit 156. The algorithm based decision module 158 for the hybrid process flow 166 may be similar to the algorithm based decisions module 152 for the standard process flow 168. The neuromorphic analog signal processor 154 has ultra-low power consumption and/or very low latency. The classification and decision making algorithms can be digital. These modules may be performed with dramatically reduced resources, power consumption, and/or using an ultra-small micro-controller unit (MCU) core. When a neural network is simulated in a digital processor (from CPU to a GPU and/or a Tensor Processing Unit (TPU)), most resources are used for primary data processing to extract embeddings (see the extraction process 148 in the standard process 168). When the input signal is data-rich, primary data processing consumes up to 80% of the capacity or computational resources. Classification and decision making consume fewer resources. Primary data processing is fixed after training. Classification and decision making constantly improve and change in the course of ongoing data accumulation and learning.

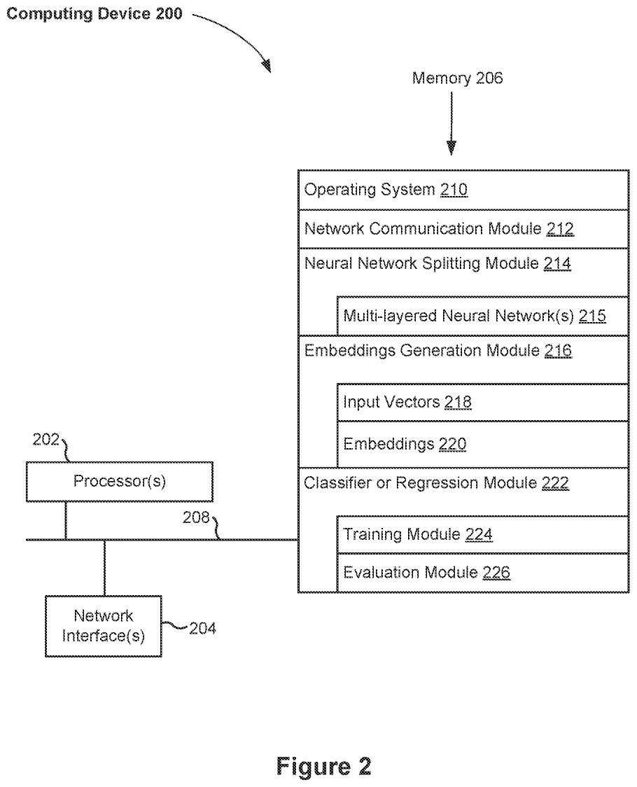

FIG. 2 is a block diagram of a computing device 200 for splitting neural networks for hybrid hardware realization of neural networks in accordance with some implementations. The computing device 200 may include one or more processing units 202 (e.g., CPUs, GPUs), one or more network interfaces 204, one or more memory units 206, and one or more communication buses 208 for interconnecting these components (e.g. a chipset).

The memory 206 includes high-speed random access memory, such as DRAM, SRAM, DDR RAM, or other random access solid state memory devices. In some implementations, the memory includes non-volatile memory, such as one or more magnetic disk storage devices, one or more optical disk storage devices, one or more flash memory devices, or one or more other non-volatile solid state storage devices. In some implementations, the memory 206 includes one or more storage devices remotely located from one or more processing units 112. The memory 206, or alternatively the non-volatile memory within the memory 206, includes a non-transitory computer readable storage medium. In some implementations, the memory 206, or the non-transitory computer readable storage medium of the memory 206, stores the following programs, modules, and data structures, or a subset or superset thereof:
an operating system 210, including procedures for handling various basic system services and for performing hardware dependent tasks;
a network communication module 212, connecting the computing device 200 to other computing devices via one or more network interfaces 204 (wired or wireless);
a neural network splitting module 214, which is configured to split multi-layered neural networks 215;
an embedding generation module 216, which generates embeddings 220 by inputting vectors 218 to layers of the multi-layered neural networks 215; and/or
a classifier or regression module 222, which builds machine learning models to classify input vectors according to a set of discrete categories of compute a value on a continuous scale. The classifier or regression module includes a training module 224 to train the classifier (e.g., a machine learning model) and an evaluation module 226 for evaluating the output of the classifier (e.g., to determine if the output satisfies a predetermined performance metric, such as a predetermined accuracy level of 98%).

Operations of the modules and the data structures shown and described above in reference to FIG. 2 are further described in reference to FIGS. 1C, 1D, 3A, 3B, 3C and 4, according to some implementations.

### Example Neural Network Applications

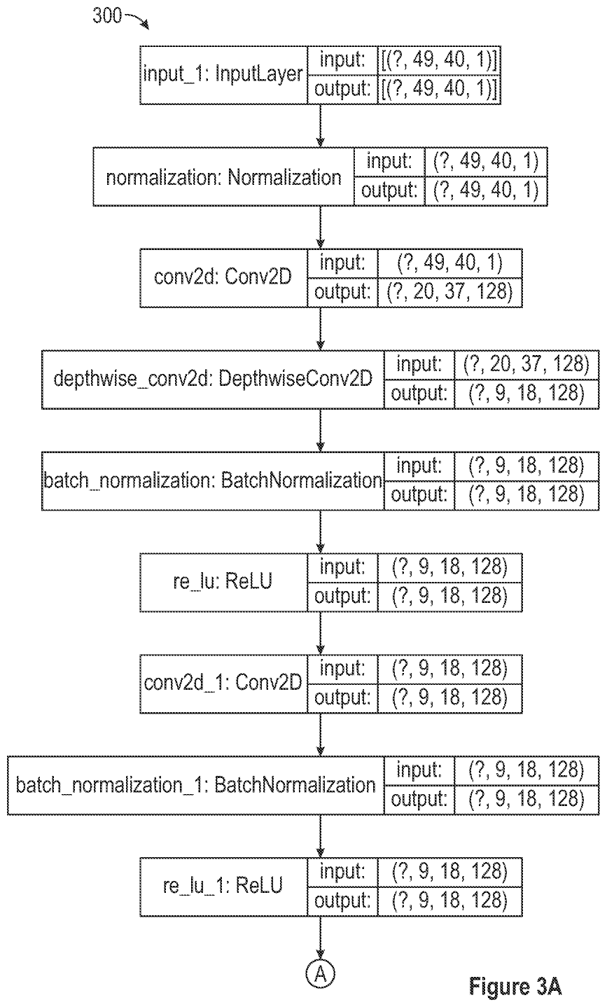

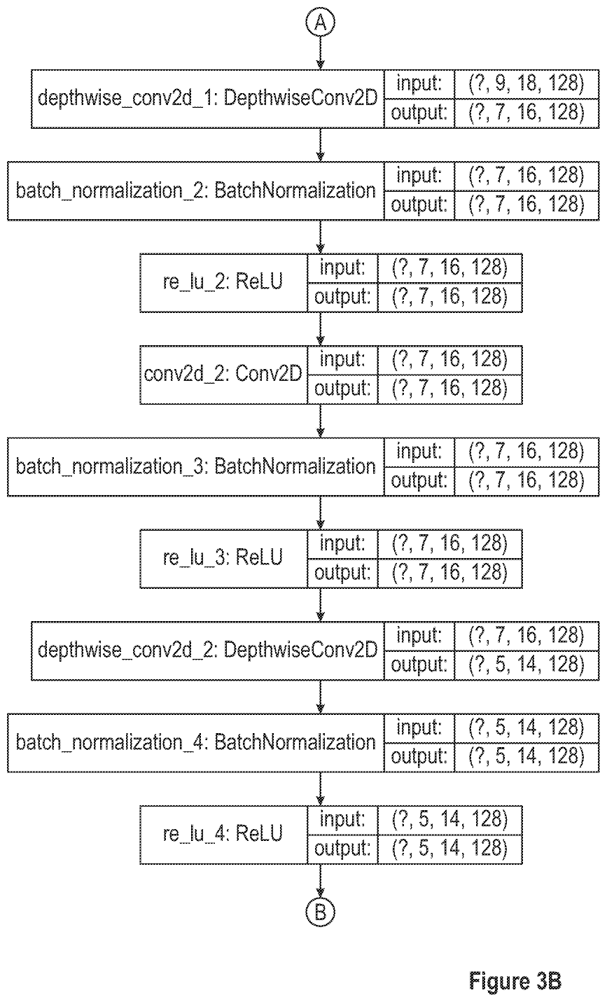

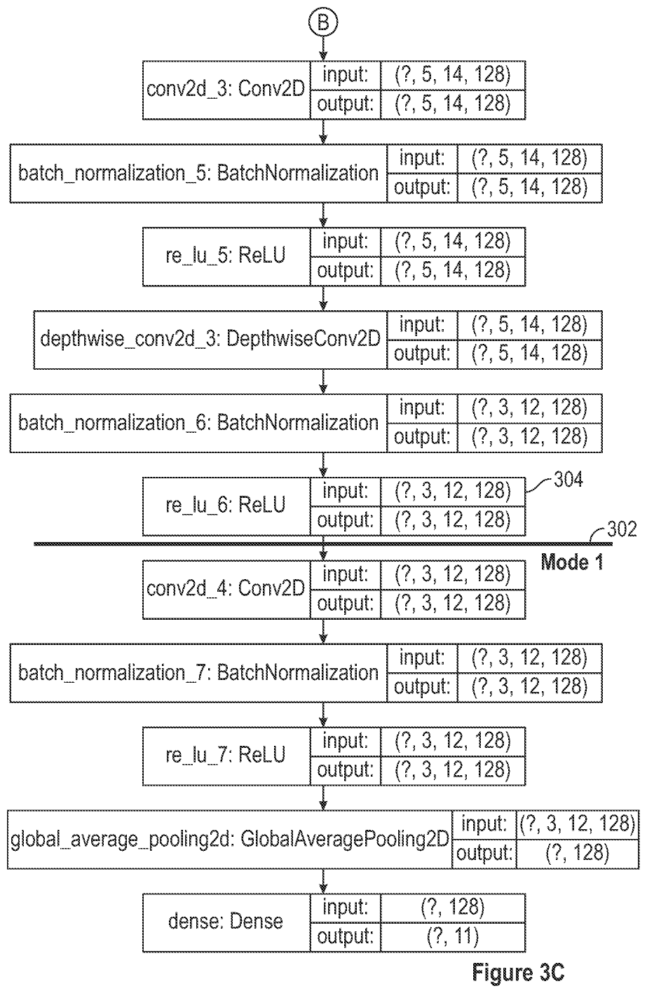

FIGS. 3A-3C provide a schematic diagram of a process 300 splitting an example keyword spotting neural network, according to some implementations. Keyword spotting networks, such as the network shown in FIGS. 3A-3C, recognize a spoken word from a list of given words. Suppose a list contains 10 words. A convolutional neural network takes a representation of a spoken word as an input and outputs a class of this word (e.g., a word from the list it matches). In FIGS. 3A-3C, the network's layers are represented by rectangles. Each rectangle includes the name of the layer and its type, input parameters, and output parameters. Parameters include the data dimension and the number of filters. In this example, the output layer has 11 outputs: one output for each word from the list plus one more (“other”) if the input word does not belong to the list. The line 302 shown in FIG. 3C splits this network into fixed and flexible parts. The fixed part is before the line, ending with the candidate layer 304. The fixed part is trained once. The flexible part is below this line. The flexible part is trained for a particular task (e.g., different word lists).

### Example Hardware Realization of Flexible Part

The flexible part can be realized in hardware using different methods. In some implementations, the flexible part is performed by a RISC V processor, which may be an integral part of an analog neuromorphic signal processor. In this case, the flexible part can be a digital controller that provides signals to interfaces and multiplexes power signals within the analog neuromorphic signal processor. Some implementations use in-memory computing and/or programmable memory tiles (e.g., flash memory, memristors, or other types of programmable memory). Some implementations use a CPU to perform a neural network for classification or a classification algorithm. The fixed part is typically compute-bound, whereas classification tends to be not as resource intensive as the fixed part.

Some implementations separate neural networks into a fixed part and a flexible part, realize the fixed part using resistors for weights, manufacture the resistors on the BEOL, and realize the flexible part at a coupled MCU or a RISC-V. The fixed part and the flexible part are an integral part of a neuromorphic analog signal processor chip, according to some implementations.

Some implementations split a neural network into a fixed part and a flexible part using transfer learning techniques. For example, a convolutional neural network is trained for data classification. The convolutional part calculates feature representations (embeddings) of the input data. These embeddings are further processed by classifiers specifically trained for other classification or regression tasks from the same data space. The weights of the portion of the neural network that produces the embeddings are fixed.

Some implementations train a deep neural network for input data feature representation using an autoencoder, a self-supervised representation learning system, or a generative adversarial network. The weights of the neural network are used to implement a fixed part of the system. Some implementations use transfer learning techniques to train fixed parts of the neural networks and then train the flexible parts. Some implementations generate embeddings using a fixed part of the network. The embeddings are analyzed by a flexible part using algorithms or neural network based analysis.

### Example Application for Human Activity Recognition

Some implementations generate embeddings for human activity recognition, based on 3-axis accelerometer signals. Some implementations use an autoencoder neural network. The autoencoder encodes various types of human activity as strings of 16 bytes (embeddings) and then decodes it without loss of accuracy. Some implementations use an analyzer neural network to decode human activities encoded in the embeddings.

In some implementations, the encoder part is implemented using fixed neurons of a neuromorphic analog signal processor chip. The flexible part (the analyzer) is implemented using a digital processor. In some implementations, the digital processor is an external CPU or a RISC-V processor of neuromorphic analog signal processor chip. In some implementations, the digital processor is used for input, output, and power management. In some implementations, embeddings are obtained using a fixed analog part of the neuromorphic analog signal processor chip. In some cases, this constitutes approximately 90% of the whole workload. In some implementations, activity recognition is performed using a digital analyzer (typically 10% of the workload) implemented using a conventional CPU.

Embeddings generated by an encoder neural network serve an important purpose. For example, if a user practices a new physical activity (e.g., riding a bicycle), a unique descriptor will be formed. The descriptor is likely to be different from other classes of embeddings. In a multi-dimensional space (e.g., a space with 16 dimensions, each dimension corresponding to a different feature), the embedding is likely to be compact and specific for bicycling. Once the user marks this activity as bicycling, that activity can be recognized next time as bicycling. In some implementations, new classes are encoded even if the classes are not present during teaching of the neural network.

### Example Application for Predictive Maintenance

In some implementations, neuromorphic analog signal processors based on the techniques described herein are used for predictive maintenance applications, such as vibration control. Typically, there is a large amount of data that flows from vibrational sensors, which are placed in machinery, cars and tracks, railway cars, wind turbines, oil and gas pumps. The data may be transferred wirelessly to an analyzing equipment. The big data flow shortens the battery life of battery-operated sensors.

Some implementations compress the data flow from vibration sensors (e.g., compress by a factor of 1000) using the encoder/decoder techniques described above. The resulting embeddings are transmitted through Long Range (LoRa). An advantage of the techniques described herein is that it is possible to create new classes that describe features of vibration sensors, even if the network was not taught to distinguish such types of features.

Some implementations use an encoder network to obtain fixed weights, which are used to implement a fixed part of a neuromorphic analog signal processor. In this way, it is possible to obtain a whole manifold of different vibration features from different vibration sensors. The different vibration features can then be analyzed by a flexible part digital analyzer, which will recognize cases of malfunction of the machine. Embeddings and encoders have an advantage that the techniques can be applied independently of the type of sensor signal.

### Example Application for Keyword Spotting

Keyword spotting typically requires recognition of different sets of words (e.g., for different languages). A neuromorphic analog signal processor needs to be adaptable. Changing the chip architecture for each new set of words is not practical. Accordingly, some implementations include a fixed part (which performs approximately 90% of the computations) and a flexible part (which performs the remaining approximately 10% of the computations). The fixed part distinguishes between different words from a certain set of data. For other sets of words, the fixed part can generate embeddings. A second flexible network is implemented to distinguish between different sets of words.

According to some implementations, a hardware apparatus includes an analog circuit (e.g., the fixed part 102, which is the circuit comprising the operational amplifiers 120 interconnected using the resistors 118) configured to receive one or more analog signals from one or more sensors, and compute an analog output based on the one or more analog signals, by performing a portion of a neural network. In some implementations, the one or more sensors are integrated (not shown) into the hardware apparatus. For example, the one or more sensors may be connected to the resistors 118 (see FIG. 1B). In some implementations, the one or more sensors include an analog sensor that is microphone sensor, piezoelectric sensor, a PPG sensor, an IMU sensor, a chemical sensor, a Lidar sensor, a Radar sensor, or a CMOS matrix sensor, examples of which are described above in reference to FIG. 1D.

The hardware apparatus also includes a classifier or regression circuit (e.g., the flexible part 104 in FIG. 1B) coupled to the analog circuit (e.g., via the interface 106). The classifier or regression circuit is configured to obtain an input signal based on the analog output and classify the input signal to obtain a result according to a machine learning model.

In some implementations, the classifier or regression circuit includes a digital circuit, examples of which are described above in reference to FIGS. 1A and 1B. The hardware apparatus further includes an analog-to-digital converter 122 coupled to the analog circuit and configured to receive and convert the analog output to a digital input. The digital circuit is configured to (i) receive the digital input and (ii) classify the digital input to obtain the result.

In some implementations, the analog output represents embeddings and the classifier or regression circuit uses the embeddings to classify or regress the analog output.

In some implementations, the analog circuit includes a plurality of operational amplifiers 120 and a plurality of resistors 118. Resistance values of the plurality of resistors are based on weights of the portion of the trained neural network. The plurality of resistors is configured to connect the plurality of operational amplifiers. In some implementations, the analog circuit includes sputtered resistors formed on the backend-of-the-line (BEOL).

In some implementations, the classifier or regression circuit includes one or more digital computing units, such as CPUs, GPUs, RISC processors, FPGAs, and ASICs.

In some implementations, the classifier or regression circuit includes a processor that is further configured to perform as a digital controller that provides signals to one or more interfaces and multiplexes power within the hardware apparatus. For example, the CPU in FIG. 2 also controls overall operation of the hardware apparatus.

In some implementations, the classifier or regression circuit includes a compute-in-memory component and one or more programmable memory tiles.

In some implementations, the classifier or regression circuit includes a network of memristors.

In some implementations, the classifier or regression circuit includes a processor configured to perform a neural network for data classification or regression. The neural network is distinct from the trained neural network. For example, the fixed part implements the first set of layers 108 of the neural network 114, whereas the flexible part implements a classifier that is different from the neural network 114.

In some implementations, the neural network is an autoencoder including an encoder portion and a decoder portion. The encoder portion performs nonlinear transformations in hidden layers. The analog circuit corresponds to the encoder portion of the autoencoder and is configured to compute a representation of the input vector in a lower dimensional space than an input space of the input vector.

In some implementations, the classifier or regression circuit is reconfigurable to train the machine learning model for a new set of inputs that is different from the set of inputs used to train the neural network.

In some implementations, the analog circuit is configured to generate embeddings that encode one or more types of human activity. The analog signal includes three-axis accelerometer signals.

In some implementations, the analog circuit is configured to generate compressed data that encodes vibration sensor data based on vibration features from vibration sensors. The analog signal includes three-axis accelerometer signals. In some implementations, the vibration sensors are configured to be placed in machinery, cars, tracks, railway cars, wind turbines, or oil and gas pumps, and the analog signal is obtained wirelessly from the vibration sensors.

In some implementations, the analog circuit is configured to generate embeddings that encode a first set of keywords. The classifier or regression circuit is configured to be retrained for a second set of keywords that is distinct from the first set of keywords.

In some implementations, the analog circuit is configured to generate pseudo-labels for unlabeled data for self-supervised representation learning.

Example Method for Splitting Neural Networks into Fixed and Flexible Parts

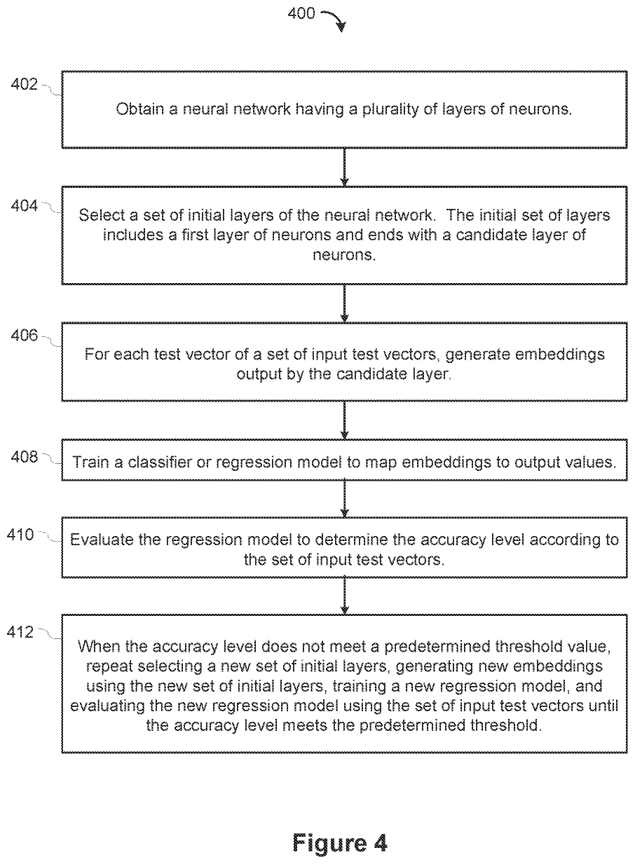

FIG. 4 provides a flowchart of a method 400 for splitting neural networks for hybrid hardware realization of neural networks in accordance with some implementations. The method may be performed by the neural network splitting module 214 and/or other modules of a computing device 200, according to some implementations. The method includes obtaining (402) a neural network 215 that has a plurality of layers of neurons. The method also includes selecting (404) a set of initial layers 108 of the neural network. The set of initial layers includes (404) a first layer of neurons and ends with a candidate layer of neurons (e.g., the last layer of the set of initial layers 108). The method also includes generating (406) (e.g., by the embedding generation module 216) embeddings 220 output by the candidate layer of neurons by inputting a set of input vectors 218 to the neural network. The method also includes training (408) (e.g., by the training module 224) a classifier or regression model to map the embeddings to output values.

The method also includes evaluating (410) (e.g., by the evaluation module 226) the classifier or regression model using a test set to determine the accuracy level and/or performance level. The test set (sometimes referred to as a dataset) includes samples. Each sample is input data. For each sample, there is typically real-world output, considered the ground truth. The data set typically includes a test set (used for validation) and a larger training set. Any general dataset that is labeled (e.g., CIFAR, COCO, or Imagenet) can be used. The predetermined threshold specifies a target performance metric (e.g., 95% accuracy for determining whether there is a car in an image). One goal is to optimize for power efficiency and flexibility. Typically, the larger the digital part, the more flexible it is, but the system has lower power efficiency.

The method also includes, when the accuracy level (or performance metric) does not meet a predetermined threshold, repeating (412) (e.g., by the neural network splitting module 214) selecting a new set of initial layers based on the set of layers, generating new embeddings using the new set of initial layers, training the classifier or regression model according to the new embeddings, and evaluating the classifier using the test set, until the accuracy level or performance metric meet the predetermined threshold.

In some implementations, the neural network splitting module 214 reduces the number of layers for the analog part, provided the classification or regression performance metric is above a threshold. A goal is for the analog part to be as maximal as possible, and the flexible part to be as minimal as possible, while providing the flexibility to classify inputs for a given domain or a given application.

In some implementations, selecting the set of initial layers and selecting the new set of initial layers are based on determining if (i) the number of operations, (ii) the number of neurons, and (iii) the dimension of resulting embeddings, are below respective predetermined threshold values.

In some implementations, selecting the set of initial layers and selecting the new set of initial layers are based on calculating energy per operation by simulating the neural network. Commercial software, such as Cadence Virtuoso, may be used for the simulation. A classifier cannot be smaller than some predetermined size, so the analog or fixed part has to be at least some size. Typically, the smaller the classifier, the smaller the set of distinct classes that can be classified.

In some implementations, selecting the set of initial layers and selecting the new set of initial layers are based on estimating energy per operation based on supply voltage, propagation time, and average working current per neuron, for the neural network.

In some implementations, the method further includes repeating the steps for a predetermined number of iterations (e.g., 5 times).

In some implementations, the method further includes using a new classifier for classifying the new embeddings after repeating the steps a predetermined number of iterations.

In some implementations, the plurality of layers of neurons includes the first layer of neurons for receiving inputs. Each layer of neurons of the plurality of layers of neurons is connected to a subsequent layer of neurons of the plurality of layers of neurons.

Example Application of Method for Splitting Neural Networks into Fixed and Flexible Parts

When selecting layers for the fixed part, some implementations take into account not only the performance metric (e.g., accuracy) of the classifier or regression model, but also the complexity of the fixed part (e.g., the number of operations, and/or the number of neurons), as well as the dimension of the embeddings.

Suppose a multi-layered neural network has 5 layers and processes input data samples of length 10. Also, suppose that the first layer includes 10 neurons, the second layer includes 20 neurons, the third layer includes 15 neurons, the fourth layer includes 10 neurons, and the last layer includes 5 neurons. Further suppose that a particular task has the following requirements: the complexity of the fixed part has to be less than 650 operations, the number of neurons has to be less than 50 neurons, and the embedding dimensionality has to be less or equal to 20. If four layers of this neural network are selected, then they produce embeddings of dimension 10 (the number of neurons in the fourth layer). The computational complexity of these four layers is defined by the number of operations to execute in order to calculate the embedding: (10 times 10) plus (10 times 20) plus (20 times 15) plus (15 times 10) results in 750 operations. The number of neurons is the sum of neurons in the selected layers, which is 10 plus 20 plus 15 plus 10, which is 55 neurons. These parameters do not meet the requirements (for the number of operations). So the method removes the fourth layer from the selection. For the remaining three layers, the complexity is (10 times 10) plus (10 times 20) plus (20 times 15), which is 600 operations. The number of neurons is 10 plus 20 plus 15, which is 45, and the embedding dimension is 15. These parameters satisfy the requirements, so the three layers are considered for the fixed part. The method includes generating embeddings for input data using these three layers and training a classifier for these embeddings. Suppose the accuracy of the classifier after training is 98%.

Subsequently, the method removes the third layer and checks the requirements for the first two layers. The complexity is now (10 times 10) plus (10 times 20), which is 300 operations. The number of neurons is 10 plus 20, which is 30, and the embedding dimension is 20. These parameters also satisfy the requirements, so these two layers are considered for the fixed part. The method includes generating embeddings for input data using these two layers as candidate layers for splitting and training a classifier for these embeddings. Now suppose the accuracy of the second classifier is 95%. The classification accuracy for the case where three layers are selected is higher than the case where two layers are selected, so the method selects three layers for the fixed part (i.e., the first three layers).

In some implementations, there are restrictions on the configuration of the analog part. Accordingly, some implementations select candidate layers for the analog part in order to satisfy these restrictions and maximize the classification accuracy of the classifier that classify embeddings. These restrictions may include energy consumption, the number of neurons in the analog part and the embedding dimension. Meeting these restrictions depends on the parameters (the number of operations, the number of neurons, and the number of neurons in the last layer) of the layers selected for the fixed part.

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

What is claimed is:

1. A hardware apparatus comprising:
an analog circuit, corresponding to a portion of a trained neural network, configured to:
obtain one or more analog signals from one or more sensors; and
compute an analog output based on the one or more analog signals; and
a classifier or regression circuit, coupled to the analog circuit, configured to:
obtain an input signal based on the analog output; and
apply a machine learning model to the input signal to either (i) classify the input signal according to a plurality of discrete categories or (ii) assign an output on a predefined continuous scale.

2. The hardware apparatus of claim 1, wherein:
the classifier or regression circuit comprises a digital circuit; and
the hardware apparatus further comprises an analog-to-digital converter coupled to the analog circuit and configured to receive and convert the analog output to a digital input.

3. The hardware apparatus of claim 1, wherein the analog output comprises a set of latent embeddings and the classifier or regression circuit applies the machine learning model to the latent embeddings.

4. The hardware apparatus of claim 1, wherein:
the analog circuit comprises a plurality of operational amplifiers and a plurality of resistors;
resistance values of the plurality of resistors are based on weights of neurons in the portion of the trained neural network; and
the plurality of resistors is configured to connect the plurality of operational amplifiers.

5. The hardware apparatus of claim 4, wherein the analog circuit comprises sputtered resistors on a backend-of-the-line (BEOL).

6. The hardware apparatus of claim 1, wherein the classifier or regression circuit comprises one or more digital computing units selected from the group consisting of: CPUs, GPUs, RISCs, FPGAs, and ASICs.

7. The hardware apparatus of claim 1, wherein the classifier or regression circuit comprises a processor that is further configured to perform as a digital controller, providing signals to one or more interfaces and multiplexing power within the hardware apparatus.

8. The hardware apparatus of claim 1, wherein the classifier or regression circuit comprises a compute-in-memory component and one or more programmable memory tiles.

9. The hardware apparatus of claim 1, wherein the classifier or regression circuit comprises a network of memristors.

10. The hardware apparatus of claim 1, wherein:
the trained neural network is an autoencoder comprising an encoder portion, having a plurality of hidden layers that compute a respective representation of each input vector in a lower dimensional space than an input space of the respective input vector, and a decoder portion that reconstructs the respective input vector;
the analog circuit corresponds to the encoder portion; and
the classifier or regression circuit corresponds to the decoder portion.

11. The hardware apparatus of claim 1, wherein the classifier or regression circuit is reconfigurable to train the machine learning model for a new set of inputs that is different from a set of inputs used to train the trained neural network.

12. The hardware apparatus of claim 1, wherein the one or more sensors include an analog sensor selected from the group consisting of: a microphone, a piezoelectric sensor, a PPG sensor, an IMU sensor, a chemical sensor, a Lidar sensor, a Radar sensor, and a CMOS matrix sensor.

13. The hardware apparatus of claim 1, wherein the analog circuit is configured to generate embeddings that encode types of human activity, and the analog signal comprises three-axis accelerometer signals.

14. The hardware apparatus of claim 1, wherein the analog circuit is configured to generate compressed data that encodes vibration sensor data based on vibration features from vibration sensors, and the analog signal comprises three-axis accelerometer signals.

15. The hardware apparatus of claim 14, wherein the vibration sensors are configured to be placed in machinery, cars, tracks, railway cars, wind turbines, or oil and gas pumps, and the analog signal is obtained wirelessly from the vibration sensors.

16. The hardware apparatus of claim 1, wherein the analog circuit is configured to generate embeddings that encode a first set of keywords, and the classifier or regression circuit is configured to be retrained for a second set of keywords that is distinct from the first set of keywords.

17. The hardware apparatus of claim 1, wherein the analog circuit is configured to generate pseudo-labels for unlabeled data for self-supervised representation learning.

18. A method of splitting neural networks into fixed and flexible portions, comprising:
obtaining a neural network having a plurality of hidden layers;
selecting an initial set of layers of the neural network, wherein the initial set of layers includes a first layer of the neural network and ends with a candidate layer;
for each test vector of a set of input test vectors, generating embeddings output by the candidate layer;
training a regression model to map embeddings to output values;
evaluating the regression model to determine an accuracy level according to the set of input test vectors; and
in accordance with a determination that the accuracy level does not meet a predetermined threshold value, repeating selecting a new set of initial layers, generating new embeddings using the new set of initial layers, training a new regression model, and evaluating the new regression model using the set of input test vectors until the accuracy level meets the predetermined threshold.

19. The method of claim 18, wherein selecting the initial set of layers and selecting the new set of initial layers are based on determining if (i) a number of operations, (ii) a number of neurons, and (iii) a dimension of resulting embeddings, are below respective predetermined threshold values.

20. The method of claim 18, wherein selecting the set of initial layers and selecting the new set of initial layers are based on calculating energy per operation by simulating the neural network.

21. The method of claim 18, wherein selecting the set of initial layers and selecting the new set of initial layers are based on estimating energy per operation based on supply voltage, propagation time, and average working current per neuron, for the neural network.

22. The method of claim 18, further comprising repeating the steps for a predetermined number of iterations.

23. A method of splitting neural networks into fixed and flexible portions, comprising:
obtaining a neural network having a plurality of hidden layers;
selecting a set of candidate hidden layers from the neural network;
selecting a set of test input vectors for the neural network;
for each of the candidate layers, computing a respective aggregate error for splitting the neural network at the respective candidate layer, including:
designated a respective fixed portion of the neural network comprising layers up to and including the respective candidate layer;
applying the respective fixed portion to each of the test input vectors to generate a respective set of test embeddings;
training a respective classifier using the respective set of test embeddings; and
computing the respective aggregate error for the respective candidate layer using the respective trained classifier and the set of test input vectors; and
selecting a splitting layer as a candidate layer having a smallest aggregate error.
